(19) United States
(12) Patent Application Publication
(10) Pub. No.: US 2026/0362094 A1
(43) Pub. Date: Nov. 12, 2026

(54) INTEGRATED SENSING FRAMEWORK WITH REGION BASED SENSING

(71) Applicant: InterDigital Patent Holdings, Inc., Wilmington, DE (US)

(72) Inventors: Jung Je Son, Warrington, PA (US); Taimoor Abbas, Sainte-Julie (CA); Anuj Sethi, Ottawa (CA); Achref Methenni, Montreal (CA); Saad Ahmad, Montreal (CA)

(73) Assignee: InterDigital Patent Holdings, Inc., Wilmington, DE (US)

(21) Appl. No.: 19/118,535

(22) PCT Filed: Nov. 1, 2023
(86) PCT No.: PCT/US2023/078395

§ 371 Date: Apr. 4, 2025

Related U.S. Application Data
(60) Provisional application No. 63/422,293, filed on Nov. 3, 2022.

(51) Int. Cl. H04W 4/38; H04W 4/021; H04W 28/24

(52) U.S. Cl. CPC H04W 4/38; H04W 4/021; H04W 28/24

(57) ABSTRACT

A first network node may comprise a processor and memory. The processor and memory of the first network node may be configured to receive a service request which indicates a request for a sensing service. The processor and memory of the first network node may be configured to determine a sensing mechanism based on the service request. The sensing mechanism may be associated with one or more base stations and/or one or more wireless transmit receive units (WTRUs) to be used for performing a sensing operation. The processor and memory of the first network node may be configured to send a sensing mechanism request to a second network node. The sensing mechanism request may indicate a request for the second network node to configure at least one of the one or more base stations and/or the one or more WTRUs to perform the sensing operation.

### CROSS-REFERENCE TO RELATED APPLICATIONS

This application claims the benefit of U.S. Provisional Patent Application No. 63/422,293 filed on Nov. 3, 2022, the entire contents of which are incorporated herein by reference.

### BACKGROUND

RAN (radio access network) based on the 5G RAT (Radio Access Technology), or Evolved E-UTRA (Evolved Universal Terrestrial Radio Access), may connect to the NextGen core network. The Access Control and Mobility Management Function (AMF) may control the Registration management, Connection management, Reachability management, and Mobility Management of a 5G network. The Session Management Function (SMF) may control the session management (including session establishment, modify and release), WTRU IP address allocation, selection, and control of UP function of a 5G network. The User Plane function (UPF) may control packet routing & forwarding, packet inspection, and traffic usage reporting of a 5G network. Sensing is not a traditional service considered in a 3GPP system, and there has not been any network entity dedicated to sensing service.

### SUMMARY

A first network node may comprise a processor and memory. The processor and memory of the first network node may be configured to receive a service request from an application function or a source wireless transmit receive unit (WTRU). The service request may indicate a request for a sensing service at a target WTRU or a target sensing area. The service request may comprise a quality of service (QoS) requirement indicating a sensing frequency at which sensing is to be performed.

The processor and memory of the first network node may be configured to determine a sensing mechanism in the target WTRU based on the service request. The sensing mechanism may comprise one or more base stations and/or one or more wireless transmit receive units (WTRUs) to be used for performing a sensing operation.

The processor and memory of the first network node may be configured to send a sensing request to a second network node. The sensing request may include the sensing mechanism to be used to perform the sensing operation in the target area and may include the QoS requirement. The sensing request may include a request for the second network node to configure at least one of the one or more base stations or the one or more WTRUs to perform the sensing operation in the target sensing area.

The processor and memory of the first network node may be configured to receive a sensing result from the second network node. The sensing result may include sensing data associated with the sensing operation from the at least one of the one or more base stations or the one or more WTRUs. The processor and memory of the first network node may be configured to receive a service request from an application function. The processor and memory of the first network node may be configured to send the sensing result to the application function (AF).

The sensing operation may comprise objective sensing, motion sensing, object tracking, or environment sensing. The processor and memory of the first network node may be configured to receive a service request which indicates a sensing type. The sensing type may comprise one or more of intrusion detection, raining detection, or drone detection. The target sensing area may indicate a geographic region where the sensing operation is to be performed. The first network node may indicate quality of service information for the sensing service. The quality-of-service (QoS) information may comprise one or more of sensing accuracy information, latency information, sensing frequency information, or sensing resolution information.

The first network node may comprise an Integrated Sensing Assistance Network Function (ISANF) and the second network node may comprise an Access and Mobility Management Function (AMF).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example reference model of 5G/NextGen network architecture.

FIG. 3 illustrates an example of integrated sensing applied to pedestrian/animal intrusion detection.

FIG. 4 illustrates an example of integrated sensing applied to intruder detection of smart home surroundings.

FIG. 5 is a system diagram illustrating a base station and a WTRU sensing objects.

FIG. 6 illustrates an example procedure of integrated sensing services with a service request from an application function.

FIG. 7 illustrates an example procedure of integrated sensing services with a service request from an application function.

FIG. 8 illustrates an example procedure of integrated sensing services with coordination by a sensing operation management function.

FIG. 9 illustrates an example procedure of integrated sensing services with coordination by a sensing operation management function.

### DETAILED DESCRIPTION

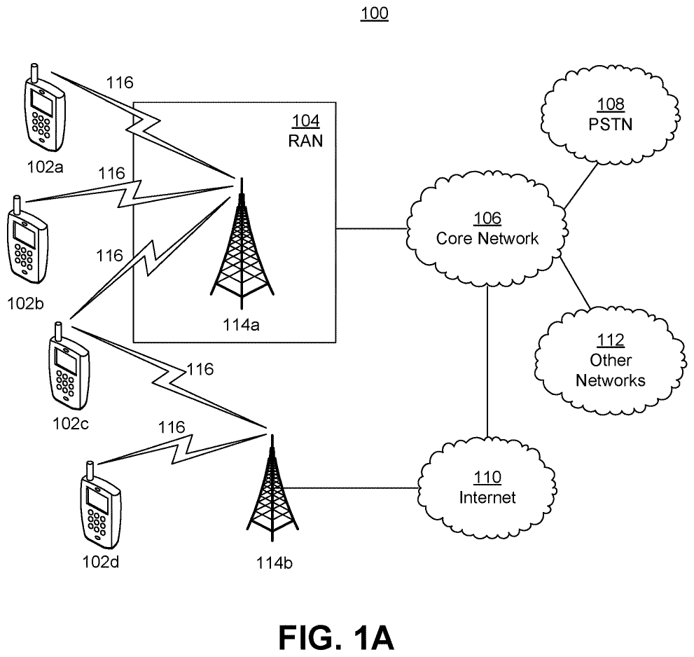

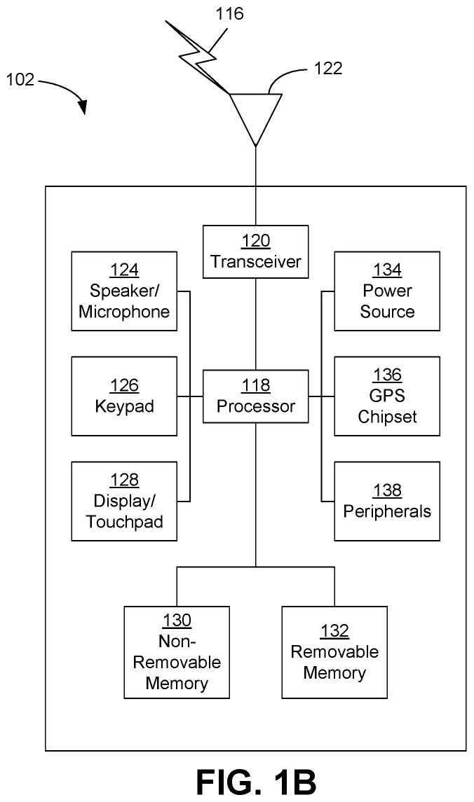

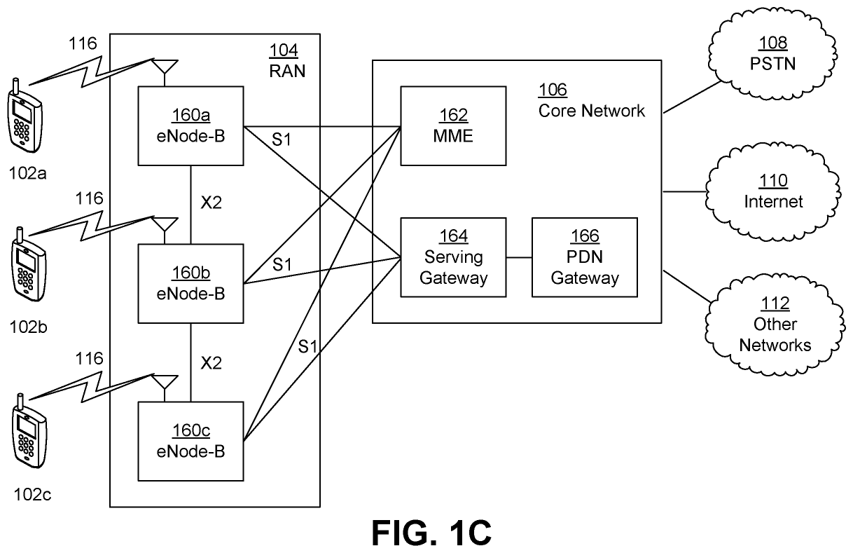

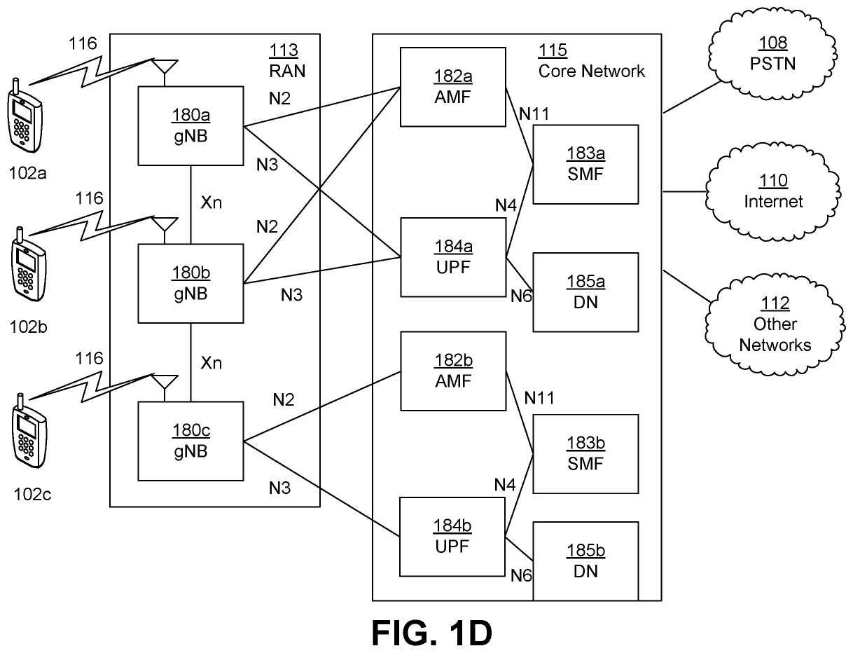

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An integrated sensing assistance network function (NF) may be described herein. The Integrated Sensing Assistance NF (ISANF) may be in charge of understanding a service request from an Application Function (AF) and deriving it into a requested sensing mechanism. After determining a requested sensing mechanism, when it was requested to be performed by certain entity, the ISANF may determine whether the indicated entity has capability to perform requested mechanism.

When a WTRU registers, the WTRU may report its capability on sensing, its mobility status (e.g., fixed, mobile), and/or a supported N3GPP sensing (if any). In some examples, the ISANF may refer to the reported WTRU's capability on sensing when it decides whether to accept or reject the request on sensing from an AF and decide proper sensing mechanism for the requested service level.

A Sensing Operation Management Function (SOMF) may be described herein. A Sensing Operation Management Function (SOMF) may be in charge of handling of interested entities (e.g., WTRU and/or base stations) for a requested sensing mechanism and communicating with those interested entities to perform sensing operation. In some examples, the SOMF may be centralized, distributed per location, or collocated with other network entity, such as AMF or a base station. After collecting sensing measurement data from a WTRU and/or a base station, the SOMF may perform sensing result decision and report the result to the ISANF.

A WTRU may perform a sensing operation based on instructions of the SOMF. The radio resource and signals which the WTRU uses to perform a sensing operation with a base station and/or other WTRU may be indicated by the SOMF and/or a base station.

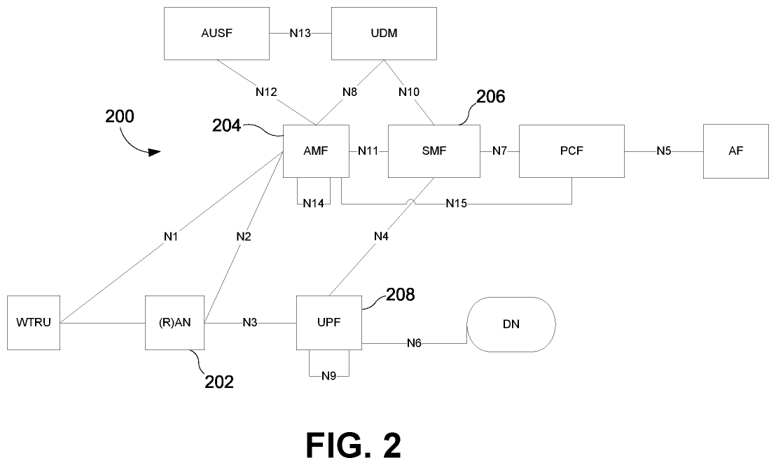

FIG. 2 illustrates a reference model of a potential architecture of 5G or NextGen network 200. RAN 202 may be a radio access network based on the 5G RAT (Radio Access Technology) or Evolved E-UTRA (Evolved Universal Terrestrial Radio Access) that connects to the NextGen core network. The Access Control and Mobility Management Function (AMF) 204 may comprise the following functionalities, registration management, connection management, reachability management, mobility management, etc. The Session Management Function (SMF) 206 may include the following functionalities, session management (e.g., session establishment, modify, and release), WTRU IP address allocation, selection, and control of UP function, etc. The User Plane Function (UPF) 208 may include the following functionalities, packet routing & forwarding, packet inspection, traffic usage reporting, etc.

The solutions described herein may be applicable to integrated sensing for enhancement of 5G system 200. Sensing services may address different target verticals/applications, for example, autonomous/assisted driving, V2X, UAVs, 3D map reconstruction, smart city, smart home, factories, healthcare, maritime sector.

For integrated sensing, sensing measurement data may be collected. Sensing measurement data may be data collected about radio/wireless signals impacted (e.g., reflected, refracted, diffracted) by an object or environment of interest for sensing purposes and derive sensing results from processing sensing measurement data. There may be an area defined for sensing (e.g., sensing service area location). A sensing service area location may be an area location (e.g., with or without obstacles) the 5G system may provide sensing service with a certain quality.

N3GPP entities may be considered for integrated sensing. Sensing measurement data in N3GPP entities may be collected and considered as transparent to 5GS. For example, the sensing measurement data may be communicated using a standard protocol to an interface defined by 5GS. An example for integrated sensing may be object detection, for example, pedestrian/animal intrusion detection on a highway or intruder detection in surroundings of a smart home.

Sensing may not be a traditional service in 3GPP systems and there may not be any network entity dedicated to sensing service(s). To provide sensing services, 5GS (5th Generation System) may be able to expose a sensing service to the AF (Application Function) so that 5GS may exchange requests and responses and provide the result with application function. 5GS may understand a service request from an application function and may trigger actions of entity within 5GS.

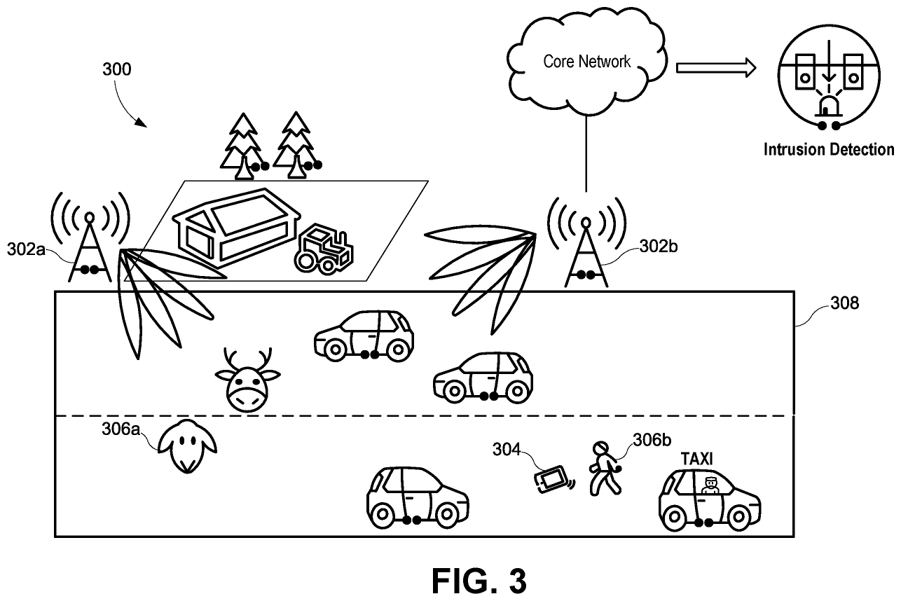

FIG. 3 illustrates an integrated sensing example of pedestrian/animal intrusion 300. In such an example, a base station 302a 302b and/or a WTRU 304 may detect intrusions 306a 306b within the sensing region (e.g., sensing service area location). The sensing region may be a highway 308. Intrusions may be animals 306a and/or pedestrians 306b.

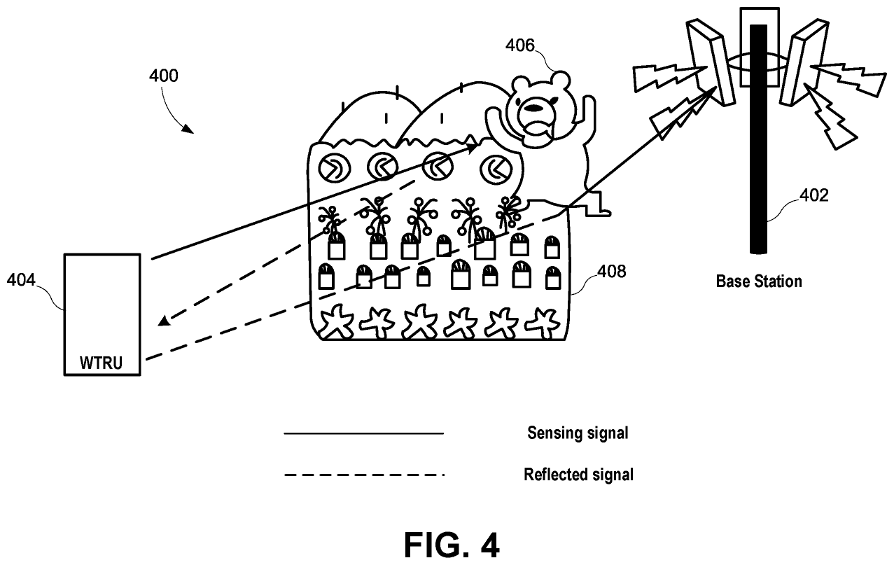

FIG. 4 illustrates an integrated sensing example 400 of intruder detection in a smart home. In such an example, a base station 402 and/or a WTRU 404 may detect the intrusion 406 in the sensing area of a base station 408. The intrusion 406 may be detected by the base station 402 or WTRU 404 by itself, and/or by collaboration between the WTRU 404 and base station 402. The sensing measurement may be transferred to the network and further processed into a sensing result.

One example of integrated sensing may be transparent sensing. Transparent sensing may be in which sensing data is captured by the WTRU and communicated so that 5GS is aware of the sensing information.

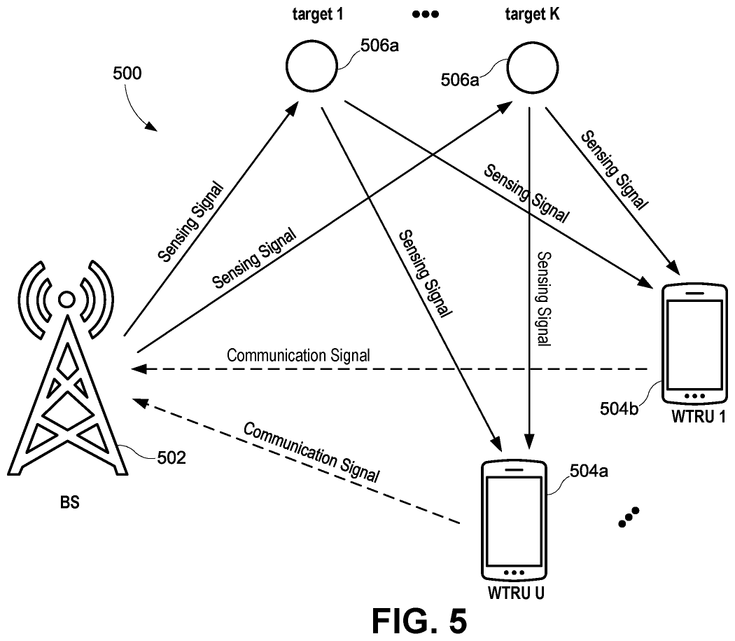

FIG. 5 illustrates an example environment 500 that includes a base station 502 and WTRUs 504a 504b performing a sensing operation. Base station 502 and WTRUs 504a 504b may sense objects 506a 506b. For example, a user terminal may acquire sense signals from many 3GPP and non3GPP devices. The 5GC may determine various available sensing services by processing collated sensing data.

A 5GS may understand a service request from an application function for sensing. If 5GS understands a service request from an application function for sensing, 5GS may trigger an operation to support sensing (e.g., sensing operation). Based on a service scenario, different entities may be included (e.g., required). An entity may be involved for different kinds of sensing services. For example, in highway intruder detection scenario 300 of FIG. 3, base stations may be involved (e.g., only base stations). For a home intrusion detection scenario 400 of FIG. 4, both a wireless transmit/receive unit (WTRU) and a Base Station (BS) may be involved. For sensing service scenarios, different action between the WTRU and the Base station may be required for collecting sensing measurement data. Based on the sensing service scenario, determining a sensing result from collected sensing measurement data may be different.

5GS may handle operations relating to sensing (e.g., select the entity, collect data, derive result). For a traditional communication service, entities perform communication (e.g., Door-to-door communication, client and server-based communication). In 5GS, service may concern WTRU(s) indicated by a service request from the AF.

Sensing services, from a service perspective, may be concerned with activity for detection (e.g., intruder detection, rain detection) and the area in which the activity for detection should be performed. A request from an AF may not include the action of specific WTRU(s). A request from an AF may include the action (e.g., sensing service) at a specific region. 5GS may translate a request from an AF into actions of entities inside 3GPP system. If 5GS translates a request from an AF into actions of entities inside 3GPP system, 5GS may trigger actions of some Base station or some WTRUs.

In 5GS (5G System), interactions between Application Function and 5GS may be possible based on a Service Based interface. For example, if an Application Function and 5GS are in trust relationship, Application Function and 5GS may interact based on a service Based interface. When an Application Function is not trusted by a 5GS (e.g., a 3^{rd} party application), the interaction may be via NEF (Network Exposure Function). For sensing services, a request from an Application Function to the 5GS may reuse an existing mechanism.

The benefits of proposed solutions may include that 5GS may provide extensible framework for unified sensing. 5GS may support the new mechanism by updating the translation rule from service request from application function to the internal action of 5GS in Sensing Assistance Function. For example, based on proposed solutions, even though new requirements or new method of sensing are introduced or updated, 5GS may support the new mechanism by updating the translation rule from service request from application function to the internal action of 5GS in Sensing Assistance Function. The solution may also support integrated sensing involving sensing data from non3GPP entities.

An Integrated Sensing Assistance Network Function (ISANF) may be in charge of interacting with an Application Function for sensing services. The ISANF may understand the service request from Application Function, and may derive a corresponding requested sensing mechanism. The ISANF may determine a corresponding requested sensing mechanism based on the service request. The ISANF may forward the request to the AMF (Access Control and Mobility Management Function). The AMF may serve the requested region or entities. An ISANF may receive a report on sensing from the AMF, or other Network Entity. For example, an ISANF may receive a report on sensing from the Sensing Operation Management Function (SOMF). ISANF may report the result to the Application Function.

An Application Function and ISANF may communicate through NEF (Network Exposure Function). For example, an Application Function and ISANF may communicate through NEF (Network Exposure Function) when the Application Function is a 3rd party application which is not a trusted entity of 5GS.

An ISANF may determine a sensing mechanism. For example, the ISANF may determine a sensing mechanism based on a Service Request from the Application Function (e.g., a sensing service request). A service request (e.g., request for sensing services) may include Quality of Service (QoS) requirements. The QoS requirements may indicate a sensing frequency for the sensing service (e.g., a sensing frequency at which the sensing is to be performed). In examples, QoS requirements of the sensing service may include sensing accuracy, latency, sensing frequency, resolution, etc. For example, intrusion detection service may require 95% sensing accuracy in an area of 5 meters vertical and 5 meters horizontal with a sensing resolution of 5 meters level and a sensing latency of 100 msec. Object tracking service (e.g., UAV tracking) may require 95% sensing accuracy in an area of 1 meter vertical and 1 meter horizontal with a sensing resolution of 1 meter level and a sensing latency of 1 msec.

In some examples, the ISANF may determine whether periodic sensing report or event triggered sensing report is needed per different sensing frequencies. The ISANF may determine periodicity of sensing measurement and/or periodicity of sensing report per different sensing frequencies.

In some examples, the ISANF may determine one or more sensing mechanisms. For example, the ISANF may determine a sensing mechanism based on a sensing scenario, sensing range, velocity accuracy, and/or sensing resolution. Sensing mechanisms may include base station only sensing (e.g., sensing of objectives or environments by exchanging signal and detecting signal among Base stations). Sensing mechanisms may include base station and WTRU collaboration-based sensing (e.g., sensing of objectives or environments by exchanging signal and detecting signal among Base stations and WTRUs). Sensing mechanisms may include PC5 based sensing (e.g., sensing of objectives or environments by exchanging signal and detecting signal among WTRU over PC5 channel). Static sensing (e.g., sensing done by 3GPP capable devices which are static/stationary (e.g., Base station, WTRUs, IoT devices, MTC devices, etc.)). Sensing mechanisms may include how many entities (e.g., the number of Base stations and/or WTRUs) should be involved.

TABLE 1

| | Sensing | | Velocity | | | Sensing | Sensing |
|---|---|---|---|---|---|---|---|
| Scenario | Ranging | | Accuracy | | Resolution | Latency | Frequency |
| Pedestrian/animal | Size of | | ≤1 | m | — | <1.5 s~<5 s | ~0.1 sec |
| intrusion detection | pedestrian or | | | | | (Note 3) | |
| in highway/railway | size of animal . . . | | | | | | |
| Train | Size of train | | 100 kmh~350 kmh | | | | |
| Rainfall monitoring | 200 | m | | | | | 1 min~15 min |
| Droning monitoring | <500 | m | <90 | kmh | 0.5 m~10 m | | |
| Obstacle detection | 500 | m | <70 | kmh | ~0.5 m | <100 ms | |

in crossroad

The ISANF may further indicate the sensing mechanism in the sensing request to the AMF. For example, ISANF may indicate the sensing mechanism in the sensing request to the AMF if there are a plurality of sensing mechanisms available. There may be a plurality of sensing mechanisms available. For example, if a sensing operation concerns the same entities there may be multiple sensing mechanisms that accomplish a single sensing operation. In an example, if a different sensing mechanism and a different sensing configuration is available for a set of Base Stations, and the expected result of the sensing will be different per the different mechanism or configuration, the ISANF may determine a sensing mechanism and indicate it in the request. The mechanism or configuration may include, for example, sensing accuracy, sensing delay, sensing range, etc.

The ISANF may check entities' capability whether it can perform the requested sensing mechanism. The ISANF may check entities' capability whether it satisfy requested QoS by querying the subscription data or other registered capability data from other Network Function (e.g., UDM, AMF, or other NF). In an example, when an ISANF identifies the entities, for example, WTRUs or Base stations, to perform the request from Application Function, the ISANF may check entities' capability whether it can perform the requested sensing mechanism and satisfy requested QoS by querying the subscription data or other registered capability data from other Network Function.

If a WTRU or a Base station is restricted to perform sensing for specific applications, the WTRU or the Base station may not, in one example, be selected to perform sensing for other sensing applications. 5GS may store a list of allowed/restricted application for sensing using a WTRU. Being stored in 5GS may include being stored, for example, in UDM (Unified Data Management) as subscription data, and/or in other NF (Network Function) as capabilities or privacy information. A list of allowed/restricted applications for sensing using a base station may be stored in 5GS. Being stored in 5GS may include being stored in a Network Function as Base station capabilities parameter.

A WTRU may report capability on sensing for sensing support. For example, the WTRU may report sensing capabilities when the WTRU registers with 5GS. The WTRU may include mobility status (e.g., fixed, mobile), and support N3GPP sensing. An ISANF may consider information reported about sensing capabilities when an ISANF checks an entities' capability.

A base station's capability on sensing may be pre-configured, recorded, and/or maintained by some network entity (e.g., UDR, ISANF, or OAM) for sensing support. For example, a base station's sensing capabilities may be pre-configured, recorded, and/or maintained by some network entity if a base station supports a specific sensing type (e.g., base station sensing only; both base station and WTRU collaboration-based sensing). A base station's capability on sensing support may be available to be referred by ISANF.

The ISANF may determine a sensing mechanism to support a service request from an Application Function based on a WTRU's capability. For example, to support a service request from Application Function, an ISANF may decide the proper sensing mechanism based on the WTRU's capabilities when the ISANF refers to the reported the WTRU's capability on sensing. In an example, if a WTRU informs the ISANF the WTRU can support N3GPP sensing (e.g., 3D Lidar, RGB Camera, or Smart Phone Camera), the ISANF may consider N3GPP (Non-3rd Generation Partnership Project) sensing capabilities when determining the sensing mechanism.

In an example, the functions of an ISANF may be deployed in an existing NF (e.g., NEF). An individual function may be deployed in a different NF. For example, translation of sensing mechanism may be deployed in NEF, deriving list of base stations and/or WTRUs may be deployed in the AMF and/or a SOMF (Sensing Operation Management Function).

In some examples, functions of an ISANF may be deployed as an application server. The ISANF may determine a sensing mechanism and requested sensing region, and a list of selected base station(s) and/or WTRU(s) may be performed by the AMF and/or SOMF. The AMF and/or SOMF may perform the selection based on various factors including, for example, the requested sensing region, the requested sensing mechanism, and the BS and/or WTRU's capability and allowed/restricted application list.

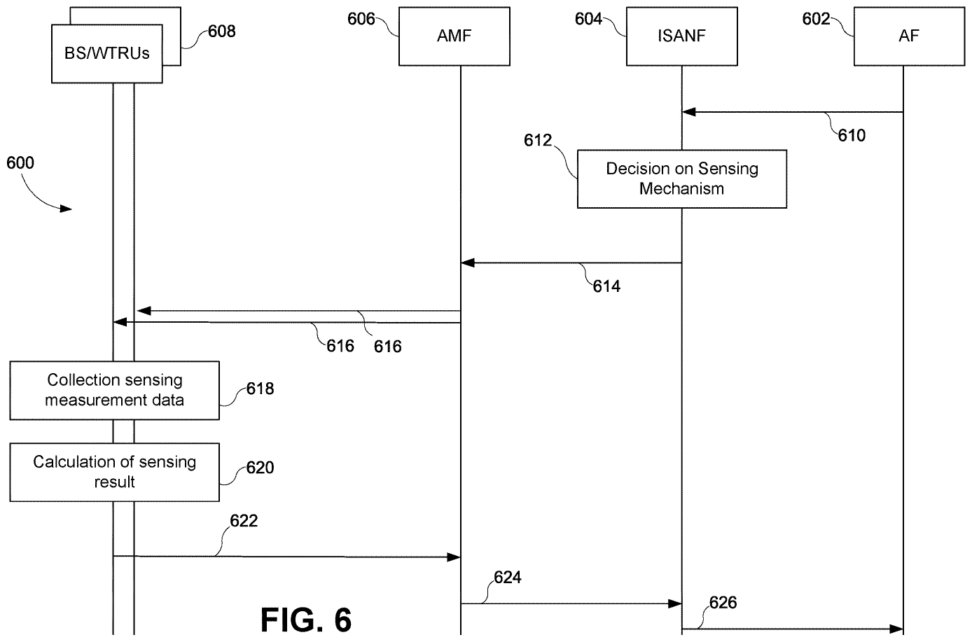

In some examples, a procedure of integrated sensing service with service request from an application function may comprise a 5GS integrated sensing procedure with a request from an application function. FIG. 6 illustrates a procedure 600 of integrated sensing service with service request from an application function (AF) 602.

At 610, the AF may send a service request (e.g., for sensing) to an ISANF 604. The service request for sensing may include a specific type of sensing request (e.g., intrusion detection, rain detection, and/or drone detection, etc.). The service request for sensing may include region information indicating an area for sensing to be performed. In an example, the service request for sensing from the AF 602 may include a specific type of sensing, and the region information (e.g., geographic region) in which the sensing should be performed.

The service request for sensing may request a sensing service at a target WTRU or a sensing service at a region which the target WTRU is located. The service request for sensing may include WTRU information. The WTRU information may indicate a list of WTRU(s) which perform sensing operation(s) (e.g., collecting sensing measurements data).

The service request may include specific QoS requirements of the sensing service. The QoS requirements may indicate a sensing frequency for the sensing service (e.g., a sensing frequency at which the sensing is to be performed). In examples, QoS requirements of the sensing service may include sensing accuracy, latency, sensing frequency, resolution, etc.

At 612, the ISANF 604 may translate the service request 610 into the requested sensing mechanism to be performed in 5GS. For example, the requested sensing mechanism may include BS only based sensing, BS and WTRU collaboration-based sensing, WTRU only based sensing, etc.

In some examples, the ISANF 604 may refer to the Policy Control Function (PCF) to check the SLA (Service Level Agreement) on the service requested from the AF 602. The ISANF 604 may determine whether a requested sensing service would be supported. The ISANF may determine which QoS requirement(s) of the requested sensing service should be supported (e.g., none).

The ISANF 604 may derive an additional candidate list of BSs and WTRUs for performing a sensing mechanism. For example, the ISANF 604 may derive additional candidate list of BSs and/or WTRUs performing sensing mechanism based on requested Region in addition to the specified WTRUs in the service request. ISANF 604 may decide the sensing mechanism and the list of BS(s) and/or WTRU(s) to perform the sensing mechanism. For example. ISANF 604 may decide the sensing mechanism and the list of BS(s) and WTRU(s) to perform the sensing mechanism based on capabilities of each BS and WTRU. If the ISANF 604 determines a list of BSs and/or WTRU(s) to perform the sensing mechanism The ISANF 604 may include WTRU specified in service request. In one example, the N3GPP sensing capability may choose proper sensing mechanism which may utilize the N3GPP sensing data, if there is any WTRU supporting the N3GPP sensing method.

At 614, the ISANF may send a Nisanf_Sensing Request message to the AMF 606. The AMF 606 may serve the requested region. The AMF 606 may be connected to and/or control a BS and/or WTRU(s) in the list of BSs and/or WTRUs to perform the sensing. The sensing request may include an application ID of an application which requested a sensing service, requested sensing region information, a BS(s) and/or WTRU(s) list, and a requested sensing mechanism with QoS requirement.

The AMF 606 may receive the Nisanf_Sensing Request from the ISANF 604. At 616, the AMF 606 may send a sensing request message to one or more individual entities 608 (e.g., a base station(s) and/or WTRUs) via the corresponding connection (e.g., N1 connection for a WTRU, N2 connection for gNB (Next Generation Node B)). The sensing request message may include the requested sensing mechanism with the QoS requirements, and the list of BSs and/or WTRUs involved.

The sensing request message for a WTRU and the sensing request message for the BS may include different information. For example, the sensing request message for the WTRU may include, for example, a sensing area which the WTRU is indicated to sense, BS's information to which the WTRU is indicated to listen, etc. The sensing request message for the BS may include configuration information (e.g., frame structure, resource assignment information, etc.). The sensing request message for the BS may include the list of the base station's information to coordinate to send a sensing signal.

The coordination of operation among BSs and WTRUs may be performed via negotiation among the involved BSs and WTRUs in a distributed manner. The coordination of operation among BSs and WTRUs may be performed via BS coordination in a centralized manner. The coordination of operation among BSs and WTRUs may include, for example, a decision of role as sender/receiver/etc., a decision of sensing period, resource scheduling for receiving a sensing signal, a waveform of sensing signal, etc. In an example, the AMF 606 may perform the coordination and include the coordination instructions in the sensing request to the individual entity 608 (e.g., the Base station and/the WTRUs) over the corresponding connection.

At 618, the BSs and/or WTRUs 608 may collect sensing measurement data. For example, the BSs and/or the WTRUs 608 may collect sensing measurement data based on the request from the AMF 606 and the coordination for sensing operation.

At 620, the BSs and/or WTRUs 608 may calculate a sensing result. In calculation of sensing result, the collected sensing measurement data may be sent to the entity which will calculate the sensing result. For example, at 622, the calculated sensing result may be sent to the AMF 606 via a sensing response. At 624, the AMF 606 may report the sensing result to the ISANF 604 via the Nisanf_Sensing response after receiving the sensing response at 622. At 626, the ISANF 604 may report the sensing result to the AF via a service response.

In some examples, the calculation of the sensing result may be performed via other entities (e.g., AMF 606, ISANF 604, or SOMF). The calculation of the sensing result may be performed (e.g., by entities other than the WTRU and/or BS 608) after receiving the collected sensing measurement data. For example, the ISANF 604 may report the calculated sensing result to the AF 602 based on the collected sensing measurement data if the ISANF calculates the sensing result. The ISANF 604 may report the calculated sensing result to the AF 602 based on the collected sensing measurement data, for example, if the BS and/or WTRU 608 sends the collected sensing measurement data to the AMF 606 at 622 and 624. The ISANF 604 may report the calculated sensing result to the AF 602 based on the collected sensing measurement data if the AMF 606 sends the collected sensing measurement data to the ISANF via the Nisanf_Sensing Response. In an example, the calculation of the sensing result may be done at the ISANF 604. The data collected by the BSs and/or WTRUs may be directly sent to ISANF 604 using a signaling message (e.g., NAS signaling message or via data path using relevant PDU session for sensing data exchange).

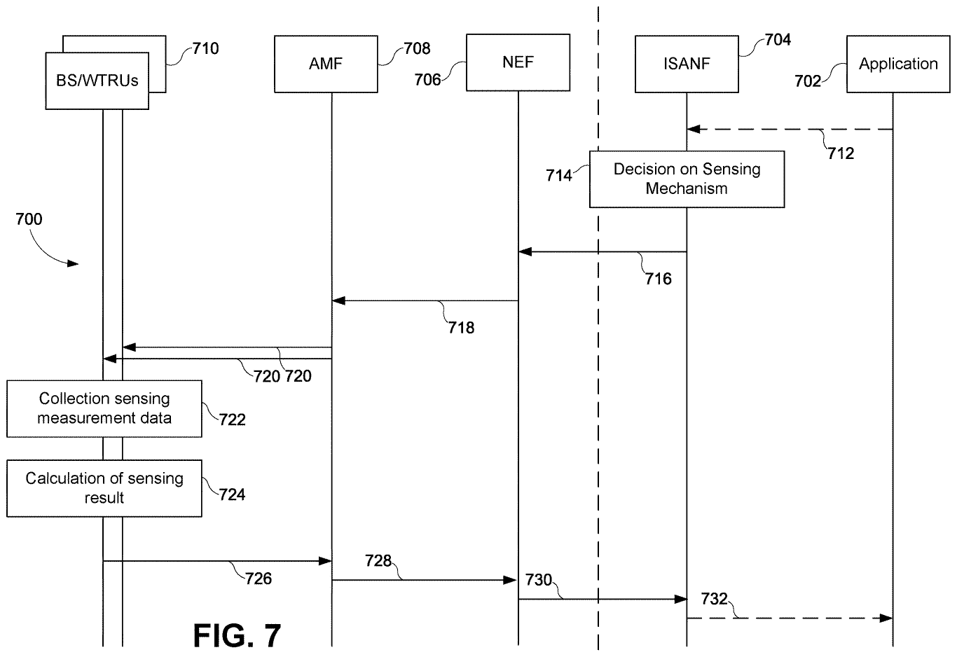

In an example, a procedure of integrated sensing service with a service request from the application function may comprise a procedure on integrated sensing of 5GS with ISANF as application function. FIG. 7 illustrates a procedure 700 of integrated sensing service with service request from an application function (AF) 702.

At 712, the AF 702 may send a service request for sensing to an ISANF 704. The ISANF 704 may be implemented as an application function outside of 5GS. In an example, ISANF 704 may be triggered via the service request for sensing (e.g., by an application, by server, by other entities, etc.). The ISANF 704 may determine the required sensing mechanism at 714. In an example, the ISANF 704 may determine the sensing mechanism based on the service request for sensing (e.g., from the AF 702).

If the ISANF 704 is outside of the 5GS, the ISANF 704 may send a service request for sensing to the NEF 706 at 716. The ISANF 704 may directly connect to a NF (e.g., AMF, PCF, UDM, etc.) for a service request. For example, if the ISANF 704 is an application function inside 5GS, the ISANF 704 may directly connect to the other NF for service requests. The service request from the ISANF 704 may include an application ID of an application which requested a sensing service, requested sensing region information, a BSs and WTRUs list, and a requested sensing mechanism with QoS requirement. The QoS requirements may indicate a sensing frequency for the sensing service (i.e., a sensing frequency at which the sensing is to be performed). In examples, QoS requirements of the sensing service may include sensing accuracy, latency, sensing frequency, resolution, etc. The service request from the ISANF 704 may include WTRU information. The WTRU information may indicate a WTRU to perform sensing operation(s) (e.g., collecting sensing measurements data).

The NEF 706 may receive the service request for sensing from the ISANF 704. The NEF 706 may derive an additional candidate list of BSs and/or WTRUs for performing a sensing mechanism. For example, the NEF 706 may derive an additional candidate list of BSs and/or WTRUs for performing a sensing mechanism based on the requested sensing region. If a WTRU is specified in the service request from the ISANF 704, the WTRU may be included in the list of BSs and/or WTRUs. The N3GPP sensing capability may be considered if there is a WTRU supporting a N3GPP sensing method.

The NEF may refer to the PCF to check the SLA on the service requested from the AF. The NEF may determine whether the requested sensing service should be supported. The NEF may determine which QoS requirement on the requested sensing service should be supported.

The NEF 706 may respond to the Service Request from the ISANF 704 with a rejection for the service. For example, if the requested sensing mechanism cannot be supported with the requested QoS requirement, the NEF 706 may respond to the Service Request from the ISANF 704 with rejection of the service. For example, the NEF 706 may determine a requested sensing mechanism cannot be supported with the requested QoS requirements if the request is not compliant with the SLA, or there is not enough availability of supporting BSs and/or WTRUs in the requested sensing region. If the requested sensing mechanism cannot be supported, the NEF 706 may include the reason for rejection (e.g., not compliant with SLA, an unsupported service region, no available entities, etc.).

At 718, the NEF 706 may send a Nnef_Sensing request message to the AMF 708. The AMF 708 may serve the requested region. The AMF 708 may be connected to and/or control the BS and/or WTRU(s) of the list of BSs and/or WTRUs to perform the sensing. The sensing request may include an application ID of an application which requested a sensing service, requested sensing region information, a BSs and WTRUs list, and a requested sensing mechanism with QoS requirement.

The AMF 708 may receive the Nnef_Sensing Request from the NEF 706. At 720, the AMF 708 may send a sensing request message to one or more individual entities 710 (e.g., the base station and/or the WTRUs) via the corresponding connection (e.g., N1 connection for the WTRU, N2 connection for gNB). The sensing request message may include the requested sensing mechanism with QoS requirements, and/or the list of BSs and/or WTRUs involved.

The coordination of operation among BSs and/or WTRUs may be performed by negotiation among the involved BSs and/or WTRUs in distributed manner. The coordination of operations among BSs and WTRUs may be performed via base station coordination in a centralized manner. The coordination of operation among BSs and/or WTRUs may include, for example, a decision of role as sender/receiver/etc., a decision of sensing period, resource scheduling for receiving sensing signal, waveform of sensing signal, etc. In an example, the AMF 708 may perform the coordination. The AMF 708 may include the coordination instructions in the sensing request to individual entity (e.g., the base station and/or the WTRUs) via the corresponding connection.

The sensing request message for a WTRU 710 and the sensing request message for a BS 710 may include different information. For example, the sensing request message for a WTRU may include sensing area which the WTRU 710 is indicated to sense, BS's information for the WTRU to listen, etc. The sensing request message for the BS 710 may include configuration information (e.g., frame structure, resource assignment information, etc.). The sensing request message for the BS 710 may include the list of base station information to coordinate sending a sensing signal.

At 722, the BSs and/or WTRUs 710 may collect sensing measurement data. For example, the BSs and/or WTRUs 710 may collect sensing measurement data based on the request 720 from the AMF 708 and the coordination of sensing operation. At 724, the BSs and/or WTRUs 710 may calculate a sensing result based on the sensing measurement data that was collected. Alternatively or additionally, the collected sensing measurement data may be sent to an entity to calculate the sensing result. At 726, the BSs and/or WTRUs 710 may send the calculated sensing result to the AMF 708.

The AMF 708 may receive the sensing result. At 728, the AMF 708 may send the sensing result to the NEF 706 (e.g., via a Nnef_Sensing Response). The AMF 708 may report the sensing result to the NEF 706 after receiving the sensing result. At 730, the NEF 706 may send the sensing result to the ISANF 704 (e.g., via a service response). The ISANF 704 may receive the service response. The service response may comprise the sensing result. At 732, the ISANF 704 may send the sensing result to the AF 702 (e.g., via a service response).

In some examples, the calculation of the sensing result may be performed by other entities (e.g., AMF, ISANF, or SOMF). The calculation of sensing result may be performed after receiving the collected sensing measurement data (e.g., by entities other than the WTRU and/or BS 710). For example, if the NEF 706 calculates the sensing result, the NEF 706 may report the calculated sensing result to the ISANF 704. The BS and/or WTRU 710 may send the collected sensing measurement data to the AMF 708. The NEF 706 may report the calculated sensing result to the ISANF 704 based on the collected sensing measurement data. The AMF 708 may send the collected sensing measurement data to the NEF 706 via the Nnef_Sensing Response. The NEF may report the calculated sensing result to the ISANF 704 based on the collected sensing measurement data.

In some examples, the ISANF 704 may calculate the sensing result. The data collected by the BSs and/or WTRUs 710 may be sent to the ISANF 704 using a signaling message (e.g., via NAS signaling message, exposure function of the NEF, data path using relevant PDU session for sensing data exchange, etc.).

For coordination of sensing operation among the BS and the WTRUs, there may be a Sensing Operation Management Function (SOMF). The SOMF may determine coordination information for sensing operation(s). For example, the SOMF may derive coordination information for sensing operations based on information received from AMF. The information received from AMF may include the requested sensing region, a list of BSs and/or WTRUs, and/or the requested sensing mechanism and QoS requirement.

The SOMF may determine the role of sensing operation(s): sender(s) of sensing signal(s), receiver(s) of sensing signal(s), entity to collect the sensing measurement data, entity to calculate sensing result. The SOMF may determine the sensing period and the waveform of sensing signal. The SOMF may ask BS(s) or sender(s) resource assignment for sending sensing signal at the sensing period.

In some examples, the SOMF may calculate the sensing result after receiving collected sensing measurements data from the BSs and the WTRUs. The SOMF may provide further analytics on sensing results, with or without the help of another analytic function. In an example, the response from the SOMF to the AMF may include an analytic result. The SOMF's response to the AMF may be reported to the AF via the ISANF.

The SOMF may refer to the capability of the WTRUs and/or BSs for coordination of sensing operation. Based on the requested sensing region, the SOMF and/or the AMF may derive a list of BSs and/or WTRUs to perform a sensing mechanism. For example, the AMF or the SOMF may derive the list of BSs and WTRUs according to the requested sensing region and referred capability of the BSs and the WTRUs on sensing. The ISANF and/or the AMF may not include list of BSs and/or WTRUs for sensing mechanism.

When there are several sensing mechanisms available for a list of BSs and/or WTRUs, the detail sensing mechanism may be indicated by the ISANF. The detail sensing mechanism, which may be indicated by the ISANF, may be included in the Sensing Request from the ISANF. In an example, the detailed sensing mechanism may be decided by the SOMF. In one example, the detail sensing mechanism may be indicated according to the channel condition, resource availability, status of BSs and/or WTRUs (e.g., computational load, resource load, power source, battery status, etc.).

The SOMF may be centralized, distributed per location, or collocated with other network entity such as AMF or Base station. When the SOMF and the AMF are collocated, signaling between the AMF and the SOMF may be replaced by AMF internal logic and signaling. When the SOMF and the base station are collocated, one of the base stations may be decided as the coordination function for different cases of sensing operation.

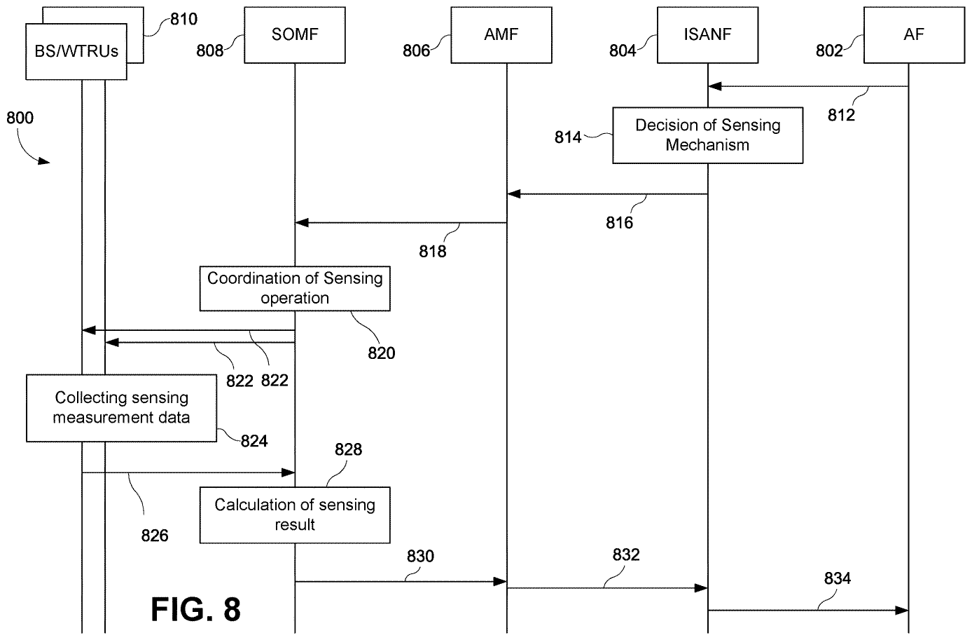

In an example, a procedure of integrated sensing service with service request from application function may comprise a procedure on integrated sensing of 5GS with coordination by the SOMF. FIG. 8 illustrates a procedure 800 of integrated sensing services with coordination by a SOMF 808. At 812, an AF 802 may send a service request for sensing to an ISANF 804. The ISANF 804 may receive the service request for sensing.

The service request for sensing may include a specific type of sensing request (e.g., intrusion detection, rain detection, drone detection, etc.) and/or region information. Region information may indicate the area in which the sensing is indicated to be performed. The service request may include WTRU information. The WTRU information may indicate a target WTRU that is to perform a sensing operation(s) (e.g., collecting sensing measurements data). The service request for sensing may include specific QoS requirements of the sensing service (e.g., sensing accuracy, latency, sensing frequency, resolution, etc.). The QoS requirements may indicate a sensing frequency for the sensing service (e.g., a sensing frequency at which the sensing is to be performed).

At 814, the ISANF 804 may translate the service request into the requested sensing mechanism, which may be performed in 5GS. The requested sensing mechanism may include, for example, BS only based sensing, BS and WTRU collaboration-based sensing, WTRU only based sensing, etc.

In some examples, the ISANF 804 may communicate with the PCF to check the SLA of the service requested by the AF 802. Based on the information received from the PCF, the ISANF 804 may decide whether the requested sensing service should be supported and which QoS requirement(s) (e.g., none, one) of the requested sensing service should be supported. Based on requested region, the ISANF 804 may derive a candidate list of BSs and/or WTRUs to perform the sensing mechanism. The ISANF 804 may determine the sensing mechanism and/or list of BSs and/or WTRUs to perform the sensing mechanism based on the capabilities of each BS and/or WTRU.

If a BS and/or WTRU supports N3GPP sensing capabilities, N3GPP sensing capabilities may be considered. N3GPP sensing capabilities may be considered to determine a proper sensing mechanism which may utilize N3GPP sensing data. For example, N3GPP sensing capabilities may be considered to choose a proper sensing mechanism which supports the N3GPP sensing data if there is any WTRU supporting a N3GPP sensing method.

At 816, the ISANF 804 may send a Nisanf_Sensing Request message to the AMF 806. The AMF 806 may serve the requested region. The AMF 806 may be connected to or control the BS and/or the WTRU(s) in the list of BSs and/or WTRUs to perform the sensing. The sensing request may comprise an application ID, requested sensing, requested sensing region information, a list of BSs and/or WTRUs, and requested sensing mechanism and QoS requirement(s).

At 816, the AMF may receive the Nisanf_Sensing Request from the ISANF 804. At 818, the AMF 806 may send a Namf_Sensing Request message to the SOMF 808. The Namf_Sensing Request message may comprise the requested sensing mechanism with the QoS requirement(s), the list of BSs and/or WTRUs involved, the application ID, and the target area.

The SOMF 808 and/or the AMF 806 may determine the sensing mechanisms and/or the list of BSs and/or WTRUs. If the AMF 806 and/or the SOMF 808 decides the sensing mechanism, the AMF 806 and/or the SOMF 808 may determine a list of candidate BSs and/or WTRUs based on the requested sensing region information. The list of BSs and/or WTRUs may be based on the requested sensing region information, sensing mechanism, and QoS requirement(s).

The AMF 806 and/or SOMF 808 may determine the sensing mechanism and list of target BSs and/or WTRUs based on the requested sensing mechanism with QoS requirement(s), the capability of entities, and allowed or restricted application list for sensing each entity in the candidate list. For example, the ISANF 804 and/or AMF 806 may not include the list of BSs and/or WTRUs and/or sensing mechanisms in the Nisanf_Sensing Request and/or the Namf_Sensing Request message.

The Namf_Sensing Request message may include a list of BSs and/or WTRUs. The list of BSs and/or WTRUs may be different from the list of BSs and/or WTRUs in the Nisanf_Sensing Request message. The AMF 806 may downselect according to the state and/or circumstance of a WTRU and/or BS. If downselecting, the AMF 806 may consider factors such as resource load and/or mobility state (e.g., idle mode, connected mode, or connected but RRC-Inactive mode).

At 820, the SOMF 808 may develop coordination information for controlling the sensing operation of the BSs and/or WTRUs in the list according to the requested sensing mechanism and QoS requirement(s) (e.g., The SOMF 808 may determine a role of a sensing operation, such as sender(s) of sensing signal(s), receiver(s) of sensing signal(s), etc.). The SOMF 808 may determine a sensing period. The sensing period may be based on the transmission or receipt of the waveform of sensing signal. The SOMF 808 may request BS(s) resource assignment for sending sensing signal at the sensing period. In an example, resource assignment for sending the sensing signal may be decided by BS(s) sensing signals. Resource assignment for sending the sensing signal may be informed another entity (e.g., BSs and/or WTRUs in the list).

At 822, the SOMF 808 may send a sensing request to one or more entities 810 involved in a sensing operation. In examples, the SOMF 808 may send the sensing request through the AMF using a NAS container when sending the sensing request to the WTRU involved.

The sensing request message for a WTRU 810 and the sensing request message for a BS 810 may comprise different information. For example, the sensing request message for a WTRU 810 may include sensing area information and BS information, etc. Sensing area information may include the target sensing area in which the WTRU is indicated to perform sensing and/or collect sensing data. BS information may provide the WTRU with the ability to listen to a BS. The sensing request message for a BS 810 may include configuration information. In examples, configuration information may be frame structure or resource assignment information. The sensing request message for a BS 810 may include the list of BS information to coordinate sending a signal. At 824, the BSs and/or WTRUs 810 may collect sensing measurement data. For example, the BSs and/or WTRUs 810 may collect sensing measurement data based on the coordination information from the SOMF 808.

At 826, the BSs and/or WTRUs 810 may send the collected sensing measurement data to the SOMF 808. At 828, the SOMF 808 may calculate a sensing result based on the collected sensing measurement data. At 830, the SOMF 808 may send sensing results to the AMF 806 via the Namf_Sensing Response. In some examples, an entity or other dedicated network function may calculate the sensing result based on the sensing measurement data that was collected (e.g., BS, WTRU, and/or other dedicated network function). In examples, a BS and/or WTRU 810 may calculate the sensing result. If a BSs and/or WTRUs 810 calculates the sensing result, the collected sensing measurement data may be sent to the BSs and/or WTRUs 810 calculating the sensing result before the sensing response is sent. At 826, the BSs and/or WTRUs 810 may send the sensing calculation results to the SOMF 808 in a sensing response. If a BS 810, or other entity, calculates the sensing result, the SOMF may not perform calculation of sensing result.

AT 830, the AMF 806 may receive the calculated sensing result from the SOMF 808. At 832, the AMF 806 may report the calculated sensing result to the ISANF 804 via the Nisanf_Sensing Response. At 834, the ISANF 804 may send the sensing result to the AF 802 via the Service Response.

In some examples, the calculation of the sensing result is performed by the AMF 806 or the ISANF 804, and the calculation of the sensing result may not be performed by the SOMF 808. If the calculation of the sensing result is performed by the AMF 806 or the ISANF 804, the collected sensing measurement data may be sent to the AMF 806 via the Namf_Sensing Response.

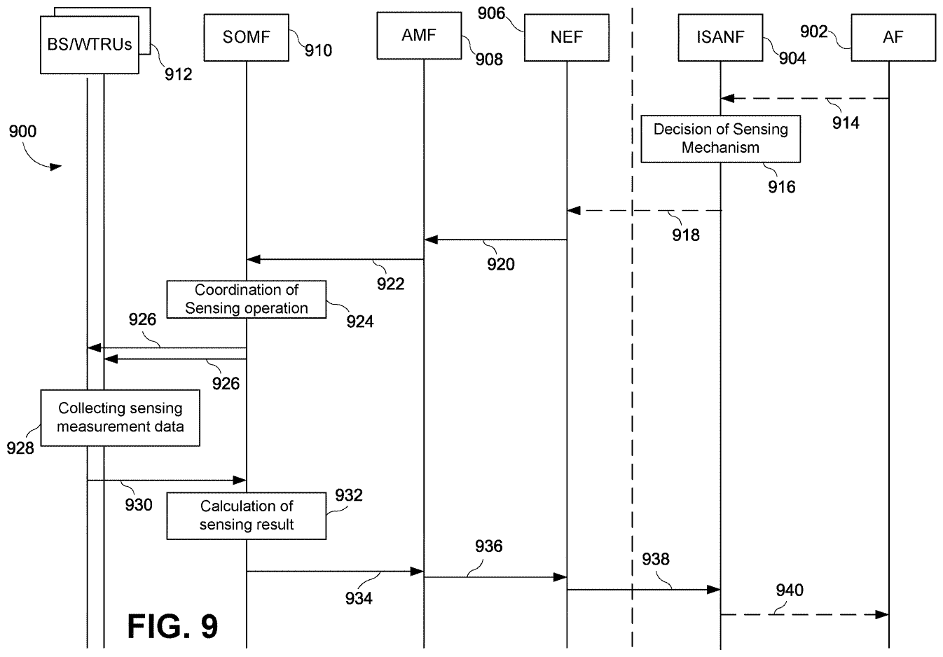

In some examples, a procedure of integrated sensing service with a service request from an application function may comprise a procedure on integrated sensing in 5GS with coordination by the SOMF and ISANF application functions. FIG. 9 illustrates a procedure 900 of integrated sensing service with coordination by a SOMF 910.

An ISANF 904 may be implemented as an AF 902 outside of 5GS. At 914, the ISANF 904 may receive a service request for sensing from the AF 902. The ISANF 904 may also be triggered by (e.g., receive a service request from) other servers, by other entities, etc. At 916, the ISANF 904 may determine the sensing mechanism for a sensing service request based on the service request for sensing.

If the ISANF 904 is outside 5GS, at 918, the ISANF 904 may send a service request for sensing to the NEF 906. If the ISANF 904 is an application function inside the 5GS, the ISANF 904 may directly connect to other NF(s) (e.g., AMF, PCF, UDM, etc.) for service request. The request from the ISANF 904 may comprise an application ID of an application which requested a sensing service, a specific type of sensing mechanism with QoS requirement(s), and/or region information in which the sensing is indicated to be performed. The QoS requirement(s) may indicate a sensing frequency for the sensing service (e.g., a sensing frequency at which the sensing is to be performed). In examples, QoS requirements of the sensing service may include sensing accuracy, latency, sensing frequency, resolution, etc.

At 918, the NEF 906 may receive the service request for sensing from the ISANF 904. The service request for sensing may include WTRU information. The WTRU information may indicate that a WTRU may perform sensing (e.g., collect measurement data). The NEF 906 may derive a candidate list of BSs and/or WTRUs that may perform the sensing mechanisms. The candidate list may be based on the requested sensing region. If a target WTRU is specified in the service request from the ISANF 904, the WTRU may be included in the candidate list of BSs and/or WTRUs. If there are any WTRUs that support N3GPP sensing methods, those N3GPP sensing capability may be considered.

In some examples, the NEF 906 may refer to the PCF and/or check the SLA on the service requested from the AF 902. The NEF 906 may refer to the PCF to determine whether requested sensing service and which QoS requirement(s) of the requested sensing service may be supported.

The NEF 906 may respond to the service request from ISANF 904 with a rejection of the service. In examples, if a requested sensing mechanism is unsupported with the requested QoS requirement(s), the NEF 906 may respond to the service request from ISANF 904 with a rejection on the service. The sensing mechanism may be unsupported with the requested QoS requirement(s) because of, for example, the SLA or (un) available BS and/or WTRU capabilities in the requested sensing region. If the NEF 906 responds to the service request from ISANF 904 with a rejection on the service, the NEF 906 may include a reason for rejection (e.g., SLA, not supported service region, unavailable available entities, etc.).

At 920, the NEF 906 may send a Nnef_Sensing Request message to the AMF 908. The AMF 908 may serve the requested sensing region. The AMF 908 may be connected to and/or control the BSs and/or WTRUs in the list of BSs and/or WTRUs to perform the sensing operation. The sensing request may include an application ID of an application which requested a sensing service, sensing region information, a list of BSs and/or WTRUs, and the requested sensing mechanism with QoS requirement(s).

At 920, the AMF 908 may receive the Nnef_Sensing Request from the NEF 906. At 922, the AMF 908 may send the Namf_Sensing Request message to the SOMF 910. The Namf_Sensing Request message may include the requested sensing mechanism with QoS requirement(s), the list of BSs and/or WTRUs, application ID, and/or target area.

In some examples, the SOMF 910 and/or the AMF 908 may determine additional candidate BSs and/or WTRUs to be included on the list. The additional candidate BSs and/or WTRUs may be based on the requested sensing region information, the requested sensing mechanism, and/or the QoS requirement(s). The additional candidate BSs and/or WTRUs may also be based on capabilities of entities and the allowed/restricted sensing application list of each entity within the candidate list. In examples, the NEF 906 and/or the AMF 908 may or may not include a list of BSs and/or WTRUs in the Nnef_Sensing Request or the Namf_Sensing Request.

The list of BSs and/or WTRUs involved in the Namf_Sensing Request may be different from the BSs and/or WTRUs' list in Nnef_Sensing Request message. For example, the AMF 908 may downselect in response to a WTRU's and/or BS's state and/or circumstance. In examples, the AMF 908 may downselect based on resource load or mobility state (e.g., idle mode, connected mode, connected but RRC-Inactive mode).

At 924, the SOMF 910 may develop coordination information for controlling the sensing operation of BSs and/or WTRUs according to the requested sensing mechanism and QoS requirement(s). The coordination information may include a role of the sensing operation of a WTRU and/or BS (e.g., sender(s) of sensing signal(s), receiver(s) of sensing signal(s), etc.). The coordination information may include a sensing period related to the transmission and receipt of the waveform of a sensing signal. The SOMF 910 may request a base station(s) resource assignment for sending a sensing signal at the sensing period. In examples, the resource assignment for sending sensing signal may be determined by a BS(s) sensing signal and may be informed other entities (e.g., BSs and/or WTRUs in the list).

At 926, the SOMF 910 may send a sensing request to the one or more entities 912 (e.g., BSs and/or WTRUs) involved in the sensing operation. When sending the sensing request to a WTRU 912, the SOMF 910 may send a sensing request through the AMF 908 using a NAS container. The sensing request message for a WTRU 912 and the sensing request message for a BS 912 may include different information. For example, the sensing request message for a WTRU 912 may include the sensing area in which the WTRU is asked to sense, BS information which may provide the WTRU with the ability to listen, etc. In examples, a sensing request message for a BS 912 may include configuration information (e.g., frame structure, resource assignment information, etc.) and/or BS information to coordinate sending a sensing signal.

At 926, one or more WTRU(s) and/or a BS(s) 912 may receive a sensing request message from the SOMF 910. At 928, the one or more BSs and/or WTRUs 912 may collect sensing measurement data based on the coordination information and sensing request from the SOMF 910. In examples, the BS and/or WTRU performing sensing is in response to the configuration and information provided by the SOMF 910. At 930, the BSs and/or WTRUs may send the collected sensing measurement data to the SOMF 910 in a sensing response message. At 932, the SOMF 910 may calculate a sensing result based on the collected sensing measurement data received the WTRU(s) and/or a BS(s) in the sensing response message. At 934, the SOMF 910 may send the sensing result to the AMF 908 via the Namf_Sensing Response.

Other entities may calculate the sensing result (e.g., a BS and/or WTRU 912 of the list, other dedicated network function). For example, if a BS calculates the sensing result, the collected sensing measurement data may be sent to the BS before the sensing response message is sent. The calculation result may be sent by the BS and/or WTRU 912 in the sensing response message and received by the SOMF 910. The SOMF 910 may not perform the calculation of sensing results.

At 934, the AMF 908 may receive the sensing result. At 936, the AMF 908 may send the sensing result to the NEF 906 via the Nnef_Sensing Response. AT 938, the NEF 906 may send the sensing result to the ISANF 904 via the service response.

In some examples, calculation of the sensing results may be performed by the ISANF 904. The BS and/or WTRU 912 may send the collected sensing data directly to the ISANF 904 via a signaling message (e.g., NAS signaling message, exposure function of NEF 906, or data path using relevant PDU session for sensing data exchange).

A service area of sensing may be defined based on the AMF's serving area, and/or based on a BS's serving area. When a sensing service is requested (e.g., a service request for sensing is received) for some region, without indicating any involved entities (e.g., a target WTRU), the ISANF may map the requested area into the service area of sensing. The ISANF may determine a list of candidate BSs and/or WTRUs available for sensing services. The ISANF may determine the sensing mechanism and the list of WTRUs and/or BSs which may be involved in the sensing operation based on the capability of entities in the list, the translated sensing mechanism, and/or the SLA.

A list of BSs and/or WTRUs may be derived for a sensing service area based on the reported BSs and/or WTRUs capabilities and known location of the BSs and/or WTRUs. When a BS connects with 5GS, the BS may report its sensing capabilities. The reported sensing capabilities may be stored with the BS's location and/or the BS's serving area of sensing. When a WTRU registers a 5GS, the WTRU may report the WTRU's capabilities supporting sensing, the WTRU's mobility type (e.g., fixed, mobile, etc.), and/or the WTRU's location (e.g., if the WTRU is a fixed device). The network entity which determines a list of WTRUs and/or BSs capable of supporting sensing services (e.g., ISANF, SOMF, or AMF, etc.) may refer to the capabilities of a BS and/or WTRUs of which location and/or serving area is known.

In some examples, the AMF may be aware of the location of a WTRU which supports sensing. If the WTRU's mobility type is mobile, and the WTRU is in connected state, the WTRU may be considered in the list for region-based sensing services. The WTRU may not want to be involved in the sensing service for a region-based sensing service. To avoid non-cooperative operation, a 5GS may consider only WTRUs which reported support for region-based sensing services during registration.

ODSCs (Operator Defined Sensing Categories on supported sensing mechanism) may be defined and assigned to a WTRU based on the WTRU's capabilities. During the registration procedure, a WTRUs may provide its sensing capabilities. ODSCs may be assigned based on the sensing capabilities provided by the WTRU via the registration response, WTRU configuration update procedure, WTRU policy update procedure, and/or via other NAS control plane signaling. ODSCs may be pre-configured in the USIM/NVM, and in some examples, updated during registration via HPLMN, via SOR in roaming scenarios. A base station may be assigned ODSCs by pre-configuration, OAM, or signalling from 5GS.

When a service request for sensing from the application function is received, the ISANF may translate the service request to an ODSC. For a requested sensing mechanism of a service request, a WTRUs and/or the BSs may be selected for a sensing operation based on an ODSC in the requested sensing region.

In some examples, the ISANF may map a given service request to an ODSC. The ODSC value may be forwarded to the AMF(s) which serve the requested sensing region. An ODSC may be provided via system information blocks (SIBs) of a base station in the AMF's serving area to WTRUs, by multicast and broadcast service to multiple WTRUs, and/or by individual NAS signalling to WTRUs. By providing a requested ODSC, the AMF may activate sensing operations in a preconfigured manner. An activated ODSC may be enabled by broadcast information at a cell level via SIBs. The periodicity of sensing and the sensing period may be sent with the ODSC, informed in a different manner, or preconfigured (e.g., per ODSC, per AMF, etc.).

The sensing measurement data of a WTRU and/or BS may be received by the SOMF and the SOMF may calculate the sensing result. The sensing result may be reported to the AMF and to the ISANF via the method of other solutions. In some examples, the SOMF may be the entity to determine the SIB contents that enables the sensing operation for a given sensing service request in a particular region (e.g., geographical).

What is claimed is:

1. A first network node comprising:
a processor and memory, the processor and memory configured to:
receive a service request for sensing from an application function (AF), the service request indicating a request for a sensing service at a target WTRU or in a target sensing area, and the service request comprising a quality of service (QoS) requirement indicating a sensing frequency at which sensing is to be performed;
determine a sensing mechanism in the target sensing area based on the service request, the sensing mechanism comprising one or more base stations or one or more WTRUs to be used for performing a sensing operation in the target sensing area; and
send a sensing request to a second network node, wherein the sensing request comprises the sensing mechanism to be used to perform the sensing operation in the target sensing area, wherein the sensing request includes the QoS requirement, and wherein the sensing request includes a request for the second network node to configure the at least one of one or more base stations or one or more WTRUs to perform the sensing operation in the target sensing area.

2. The first network node of claim 1, wherein the processor and memory are further configured to:
receive a sensing result from the second network node, the sensing result comprising sensing data associated with the sensing operation from the at least one of the one or more base stations or the one or more WTRUs.

3. The first network node of claim 2, wherein the processor and memory are further configured to send the sensing result to the AF.

4. The first network node of claim 1, wherein the sensing operation comprises objective sensing, motion sensing, object tracking, or environment sensing.

5. The first network node of claim 1, wherein the service request indicates a sensing type.

6. The first network node of claim 5, wherein the sensing type comprises one or more of intrusion detection, raining detection, or drone detection.

7. The first network node of claim 1, wherein the target sensing area indicates a geographic region where the sensing operation is to be performed.

8. The first network node of claim 1, wherein the service request comprises WTRU information, the WTRU information indicating the target WTRU to perform sensing operation(s).

9. The first network node of claim 1, wherein the QoS requirement comprises sensing accuracy information, latency information, sensing frequency information, or sensing resolution information.

10. The first network node of claim 1, wherein the first network node comprises an integrated sensing assistance network function (ISANF), and the second network node comprises an access and mobility management function (AMF).

11. A method performed by a first network node comprising a processor and memory, the method comprising:
receiving a service request for sensing from application function (AF), the service request indicating a request for a sensing service at a target WTRU or in a target sensing area, and the service request comprising a quality of service (QoS) requirement indicating a sensing frequency at which sensing is to be performed;
determining a sensing mechanism in the target sensing area based on the service request, the sensing mechanism comprising one or more base stations or one or more WTRUs to be used for performing a sensing operation in the target sensing area; and
sending a sensing request to a second network node, wherein the sensing request comprises the sensing mechanism to be used to perform the sensing operation in the target sensing area, wherein the sensing request includes the QoS requirement, and wherein the sensing request includes a request for the second network node to configure the at least one of one or more base stations or one or more WTRUs to perform the sensing operation in the target sensing area.

12. The method performed by the first network node of claim 11, the method further comprising:
receiving a sensing result from the second network node, the sensing result comprising sensing data associated with the sensing operation from the at least one of the one or more base stations or the one or more WTRUs.

13. The method performed by the first network node of claim 12, wherein the processor and memory are further configured to send the sensing result to the AF.

14. The method performed by the first network node of claim 11, wherein the sensing operation comprises objective sensing, motion sensing, object tracking, or environment sensing.

15. The method performed by the first network node of claim 11, wherein the service request indicates a sensing type.

16. The method performed by the first network node of claim 15, wherein the sensing type comprises one or more of intrusion detection, raining detection, or drone detection.

17. The method performed by the first network node of claim 11, wherein the target sensing area indicates a geographic region where the sensing operation is to be performed.

18. The method performed by the first network node of claim 11, wherein the service request comprises WTRU information, the WTRU information indicating the target WTRU to perform sensing operation(s).

19. The method performed by the first network node of claim 11, wherein the QoS requirement comprises one or more of sensing accuracy information, latency information, sensing frequency information, or sensing resolution information.

20. The method performed by the first network node of claim 11, wherein the first network node comprises an integrated sensing assistance network function (ISANF) and the second network node comprises an access and mobility management function (AMF).
